(19) United States
(12) Patent Application Publication
(10) Pub. No.: US 2010/0259776 A1
(43) Pub. Date: Oct. 14, 2010

(54) IMAGE FORMING APPARATUS, CONTROL METHOD THEREOF AND STORAGE MEDIUM

(75) Inventor: Masanobu Inui, Chigasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/759,163

(22) Filed: Apr. 13, 2010

(30) Foreign Application Priority Data
Apr. 13, 2009 (JP) 2009-096997

(51) Int. Cl. H04N 1/60; G06F 3/12

(52) U.S. Cl. 358/1.9; 358/1.15

(57) ABSTRACT

An image forming apparatus capable of executing an operation mode setting by a minimum operation. The image forming apparatus is connected to an external storage apparatus. An obtaining unit obtains information indicating resolution or a color mode on image data stored in the connected external storage apparatus. A setting unit sets the operation mode including resolution or a color mode when an image forming job is executed in the image forming apparatus based on the information obtained by the obtaining unit. A generating unit generates an image file including an image parameter and image data according to the operation mode set by the setting unit. A writing unit writes the image file generated by the generating unit in the external storage apparatus.

### BACKGROUND OF THE INVENTION

1. Field of the Invention

The present invention relates to an image forming apparatus, a control method thereof and a storage medium storing a program for executing the control method capable of outputting storage information to an external storage apparatus such as a USB (Universal Serial Bus) memory and a memory card, which can be freely connected to and disconnected from the image forming apparatus, and inputting the storage information from the external storage apparatus.

2. Description of the Related Art

Recently, the following has been proposed as an image forming apparatus with a printer function, a copy function, a FAX function, a scanner function, and the like such as an MFP (Multifunction Peripheral). That is, an image forming apparatus enabled to mount and connect a USB memory, a memory card, and the like (hereinafter, referred to as “removable medium”) usable by common standards to another peripheral equipment as an external storage apparatus has been proposed.

In such an image forming apparatus, storage information in the removable medium inserted to an insert port can be printed, or can be transmitted by facsimile, and a scanned image can be also stored in the removable medium. Another machine such as a PC is not needed for realizing such functions, so that the convenience is very high.

However, to use such functions, it is necessary to execute a variety of settings for a color mode, resolution, an image format, a document size, and the like on an operation part, thereby enforcing considerable man-hour work on a user.

The operation part of the image forming apparatus includes a variety of types such as a type capable of displaying and setting a plurality of pieces of information, and a type capable of displaying only one line of information, and on the operation part with small amount of displayed information, it is necessary to update the display of the operation part many times to display all of the necessary information, as a result, there is a problem that man-hour in setting an operation mode increases. To cope with this problem, a countermeasure for the user to be able to easily execute an operation mode setting is required.

Under such a background, the image forming apparatus has been proposed, in which information on the operation mode setting is provided in the storage information in the removable medium, and a variety of the functions are realized by using the provided information (See Japanese Laid-Open Patent Publication (Kokai) No. 2007-295298).

However, in the above conventional technique, work occurs for reserving the information on the operation mode setting as a file in the removable medium, so that such a problem is included that some work is required.

### SUMMARY OF THE INVENTION

The present invention provides an image forming apparatus, a control method thereof and a storage medium storing a program for executing the control method capable of executing an operation mode setting by a minimum operation.

Accordingly, an image forming apparatus of the present invention connected to an external storage apparatus is provided with an obtaining unit configured to obtain information indicating resolution or a color mode on image data stored in the connected external storage apparatus, a setting unit configured to set an operation mode including resolution or a color mode when an image forming job is executed in the image forming apparatus based on the information obtained by the obtaining unit, a generating unit configured to generate an image file including an image parameter and image data according to the operation mode set by the setting unit, and a writing unit configured to write the image file generated by the generating unit in the external storage apparatus.

According to the image forming apparatus of the present invention, the operation mode setting can be executed by a minimum operation.

Further features of the present invention will become apparent from the following description of exemplary embodiments (with reference to the attached drawings).

### BRIEF DESCRIPTION OF THE DRAWINGS

FIG. 1 is a block diagram showing a hardware configuration of an MFP as an image forming apparatus according to an embodiment of the present invention;

FIG. 2 is a table showing an example of an operation mode which can be designated to the MFP of FIG. 1;

FIG. 3 is a table showing image parameters included in a TIFF file which is an example of image data processed by the MFP of FIG. 1;

FIG. 4 is a view showing an example of a removable medium of FIG. 1;

FIGS. 5A and 5B are views showing an example of a screen displayed on an operation panel of FIG. 1;

FIG. 6 is a view showing, in a table form, information read from an image file retrieved from files stored in the removable medium of FIG. 1;

FIG. 7 is a table showing an operation mode take-over setting of the MFP of FIG. 1;

FIGS. 8A and 8B are flowcharts showing a process executed by the MFP of FIG. 1 when the removable medium is connected; and

FIG. 9 is a flowchart showing a process executed by the MFP of FIG. 1 when the removable medium is demounted.

### DESCRIPTION OF THE EMBODIMENTS

The present invention will be described in detail below as referring to the drawings.

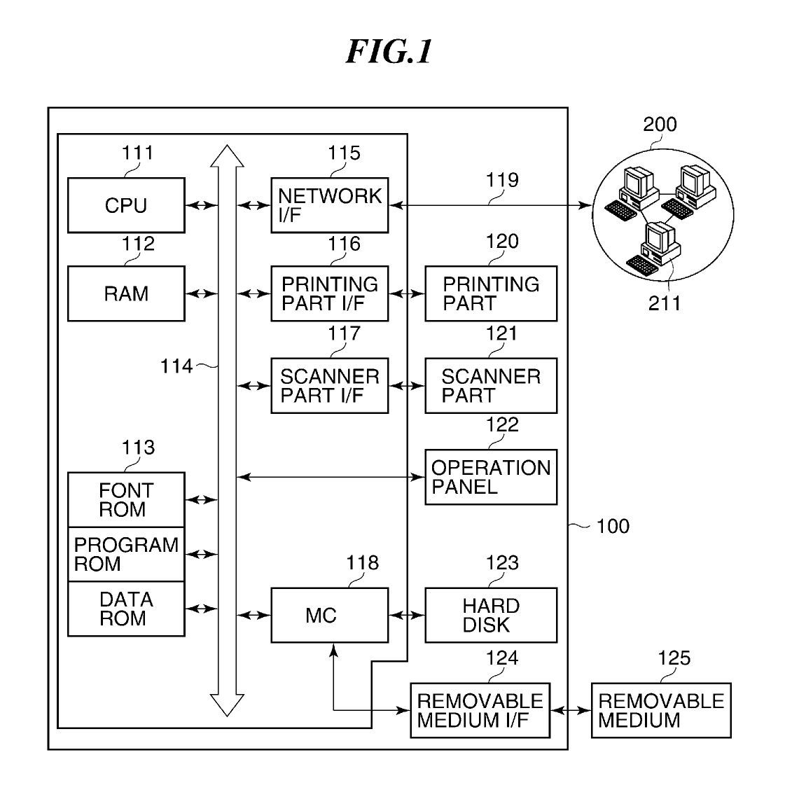

FIG. 1 is a block diagram showing a hardware configuration of an MFP 100 as an image forming apparatus according to an embodiment of the present invention.

In the MFP 100 of FIG. 1, a CPU 111 executes the following processes based on a control program stored in a program ROM area of a ROM 113, a control program stored in a hard disk 123, or the like.

That is, the CPU 111 totally controls an access with a variety of devices connected to a system bus 114, and outputs an image signal as output information to a printing part (printer engine) 120 connected through a printing part I/F (Interface) 116.

The CPU 111 processes input information from a scanner part (scanner engine) 121 connected through a scanner part I/F 117. A control program of the CPU 111 showed in a flowchart according to the present embodiment and the like may be stored in a program ROM of the ROM 113.

Font data, and the like used when the above output information is generated are stored in a font ROM of the ROM 113, and information, and the like utilized on a host computer 211 are stored in a data ROM of the ROM 113 when the image forming apparatus does not include the hard disk 123.

The CPU 111 can communicate with the host computer 211 through a network I/F 115, and is configured so as to be able to notify the host computer 211 of information, and the like in the MFP 100. The network I/F 115 is connected to a network 119, and is configured so as to be able to access an Internet 200.

A RAM 112 functions as a main memory, a work area, and the like of the CPU 111, and is configured so that a memory capacity can be expanded by an option RAM connected to a not-showed expanded port.

It should be noted that the RAM 112 is used for an output information development area, an environmental data storage area, an NVRAM, and the like. An access of the hard disk 123 such as a hard disk (HD) or a memory card is controlled by an MC (memory controller) 118.

The hard disk 123 is connected as an option, and stores font data, an emulation program, form data, and the like. A configuration in which a plurality of external memories which store an option font card and a program for interpreting a printer control language of a different language system in addition to an incorporated font can be connected may be adopted.

A switch, an LED display, and the like for the operation are arranged on an operation panel 122. Further, the not-shown NVRAM is included, and may store printer mode setting information from the operation panel 122. The scanner part 121 reads document, and the like, and outputs image data through the scanner part I/F 117.

The network 119 is configured so as to be able to communicate by a predetermined protocol with the host computer 211 provided with a hardware resource equivalent to the MFP 100.

A removable medium I/F 124 is a USB insert port or a card reader part. The removable medium I/F 124 is provided with a function for sensing whether or not a removable medium 125 is inserted, which stores a variety of pieces of information such as the image data, and a function for, in response to sensing an insert state of the removable medium 125, notifying the CPU 111 of that effect.

Upon receiving the above notice, the CPU 111 controls a function using the removable medium 125.

For example, the CPU 111 controls a function (direct print) for directly reading the image data stored in the removable medium 125, and printing the read image data by the printing part 120.

The CPU 111 controls a function (scan to memory) for reserving the information from the scanner part 121 in the removable medium 125. The CPU 111 controls to display a function for using the removable medium 125 on the operation panel 122.

It should be noted that the card reader part of the removable medium I/F 124 is configured with a memory slot corresponding to a plurality of media, each of which is standardized to a mutually deferent standard. Thus, even when the card reader part is configured so that the image data can be read from, for example, an SD memory, a compact flash (trade mark), a memory stick, a flash memory, and the like instead of the memory card, the present invention can be applied.

It should be noted that the above information stored in the above removable medium 125 (external storage apparatus) is, for example, a data file generated by a user executing an application installed in the host computer 211. It is assumed that this data file includes, for example, image data, graphics data, text data, a variety of types of data including combination data of such data, or image pickup data shot by a digital camera.

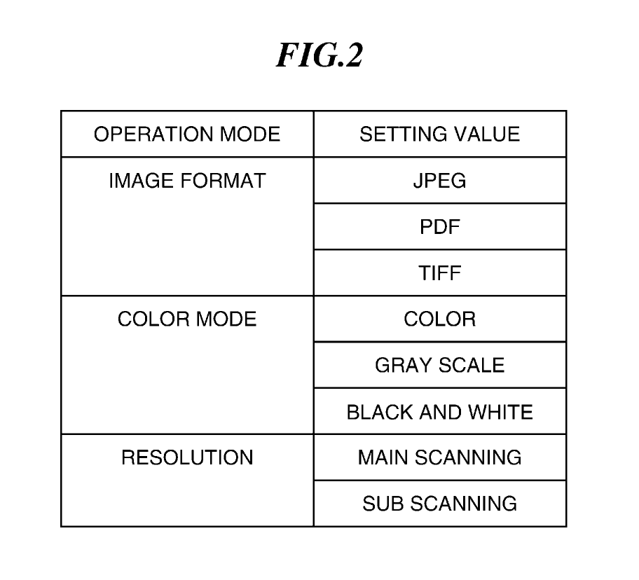

FIG. 2 is a table showing an example of an operation mode which can be designated to the MFP 100 of FIG. 1.

As an image format, JPEG, PDF, or TIFF can be designated. For information on a taken-in color, color, gray scale, or black and white can be designated. For the resolution, a numerical value can be designated to each of a main scanning and a sub scanning.

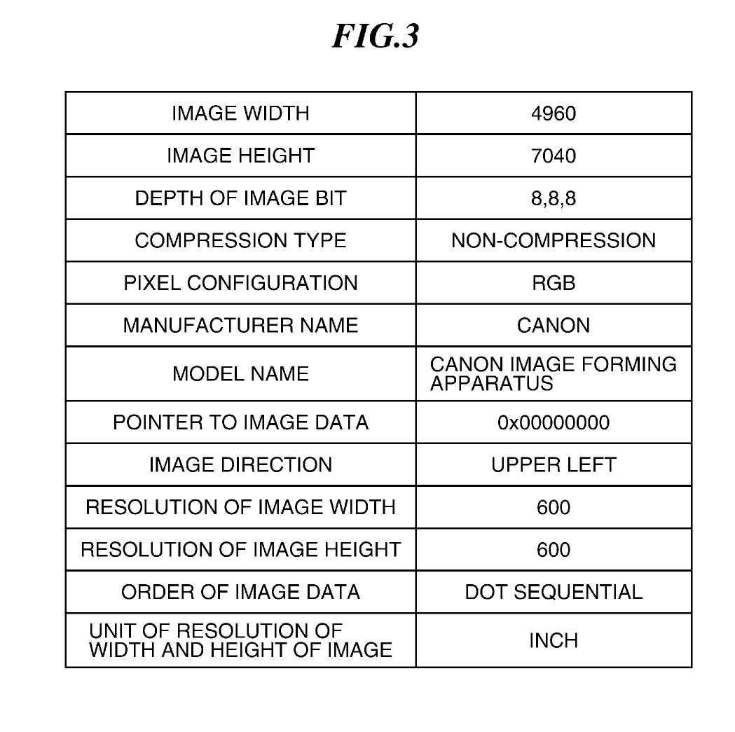

FIG. 3 is a table showing image parameters included in a TIFF file which is an example of the image data processed by the MFP 100 of FIG. 1.

Such parameters indicate information on the image data generated by the MFP 100, is generated when an image is formed according to the operation mode designated in FIG. 2, and is added to the image data.

For example, by setting a color mode indicated in FIG. 2, a pixel configuration and a depth of an image bit are changed. The pixel configuration consists of RGB in FIG. 3, so that the generated image data becomes a file generated in colors. By setting the resolution indicated in FIG. 2, the resolution of an image width, the resolution of an image height, and a unit of the resolution of the width and the height of an image are changed. In FIG. 3, 600 dpi is designated as the resolution of the image width and the image height.

The image data and the image parameter include predetermined relations therebetween shown in FIG. 3, so that it also becomes possible to identify from the image data an operation mode setting in which the image parameter is generated.

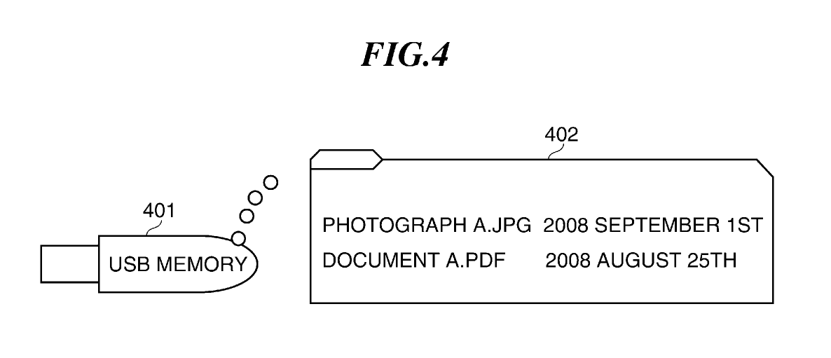

FIG. 4 is a view showing an example of the removable medium 125 of FIG. 1.

A USB memory 401 as the removable medium 125 can be connected to the MFP 100. The image data can be stored in the USB memory 401, and is stored as a file 402 with date information.

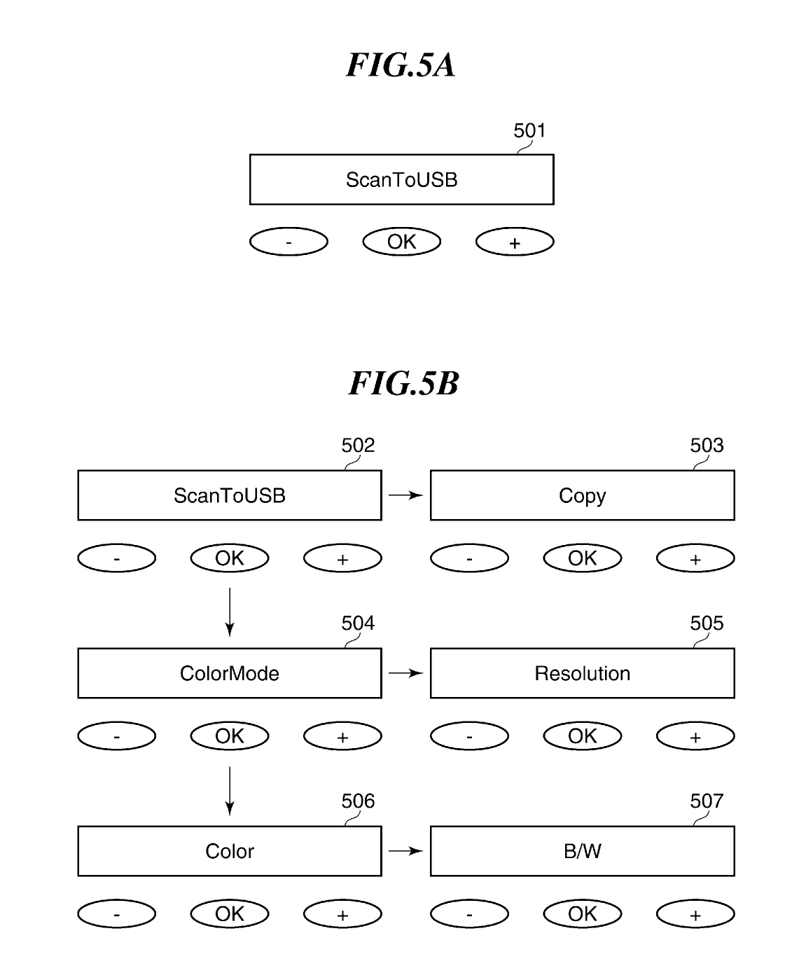

FIGS. 5A and 5B are views showing an example of a screen displayed on the operation panel 122 of FIG. 1.

One line of a message can be displayed on a screen 501 of FIG. 5A, and the operation panel 122 is provided with a minus button, a plus button, and an OK button. By depressing such buttons, the user finds the target operation mode, and causes the screen to move to the screen for setting a value of the target mode by depressing a key of the operation panel 122.

A particular exemplary operation will be described by using screens 502 to 507.

In the screen 502 of FIG. 5B, ScanToUSB is displayed as a type of a job. In this case, when the plus or minus button is depressed, a job type can be changed.

The screen obtained by changing the job type by depressing the plus button will be shown in the screen 503. By depressing the OK button, the screen moves to the screen for executing the operation mode setting. For example, when the ScanToUSB is displayed, the screen obtained by depressing the OK button will be displayed in the screen 504. In this screen, the color mode of the operation modes which can be set in a ScanToUSB job is displayed.

While the screen 504 is being displayed, and when the plus or minus button is depressed, another operation mode can be displayed. For example, the screen obtained by depressing the plus button and changing the operation mode will be shown in the screen 505. The screen obtained by depressing the OK button while the color mode is being displayed as the operation mode will be shown in the screen 506.

Further, while the setting value of the operation mode is being displayed on the screen, by depressing the OK button, the setting value in the operation mode can be determined. For example, while the screen 506 is being displayed, the OK button is depressed so that “color” is determined as the setting value of the color mode. On this screen, when the plus or minus button is depressed, the setting value of the color mode can be changed.

The screen obtained by depressing the plus button and changing the setting value in the color mode will be shown in the screen 507.

In the present embodiment, by executing the above operation for all the operation modes which need to be changed, it is possible to determine the operation mode to be set to the job.

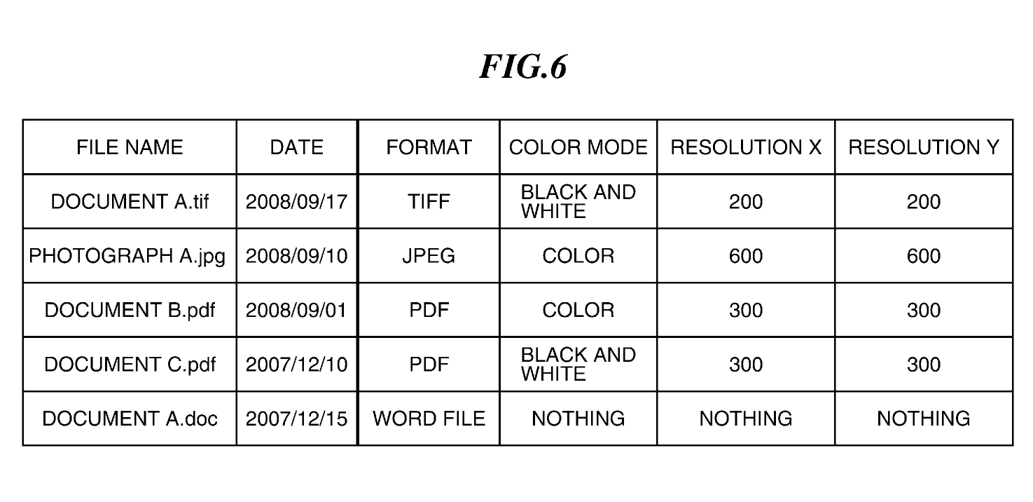

FIG. 6 is a view showing, in a table form, information read from the image file retrieved from the files stored in the removable medium 125 of FIG. 1.

The read information is temporarily stored in the hard disk 123 or the RAM 112. In this example, the five files are retrieved, and the following items are enumerated: a file name of the image file; a date when the image file is generated; a file format derived from the file name of the image file; the color mode derived from the image parameter in the image file; and the resolution. Even when a file which is not an image file, such as a Word file, is included in the USB, such items are also enumerated. However, such files do not include information such as the color mode and the resolution, so such items are not enumerated as the image information.

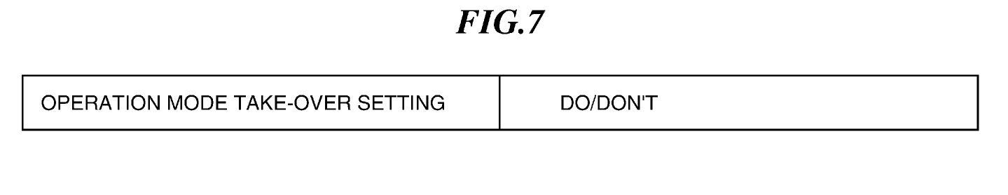

FIG. 7 is a table showing an operation mode take-over setting of the MFP 100 of FIG. 1.

Information on this setting is reserved in the RAM 112 or the hard disk 123, and any of choices of “do” and “don't” can be selected. A method for changing the setting will be described later.

Here, the CPU 111 designates the operation mode when an image forming job is executed, and generates the image file including the image parameter and the image data corresponding to the designated operation mode. The CPU 111 writes the generated image file in the external storage apparatus (the removable medium 125), reads the written image file from the external storage apparatus, and executes the image forming job.

The CPU 111 displays the image parameter of the image file on the operation panel 122, and determines based on an operation input to the operation panel 122 whether or not to change the displayed image parameter. When determining to change the displayed image parameter, the CPU 111 retrieves the image file including the image parameter which is similar to the changed image parameter.

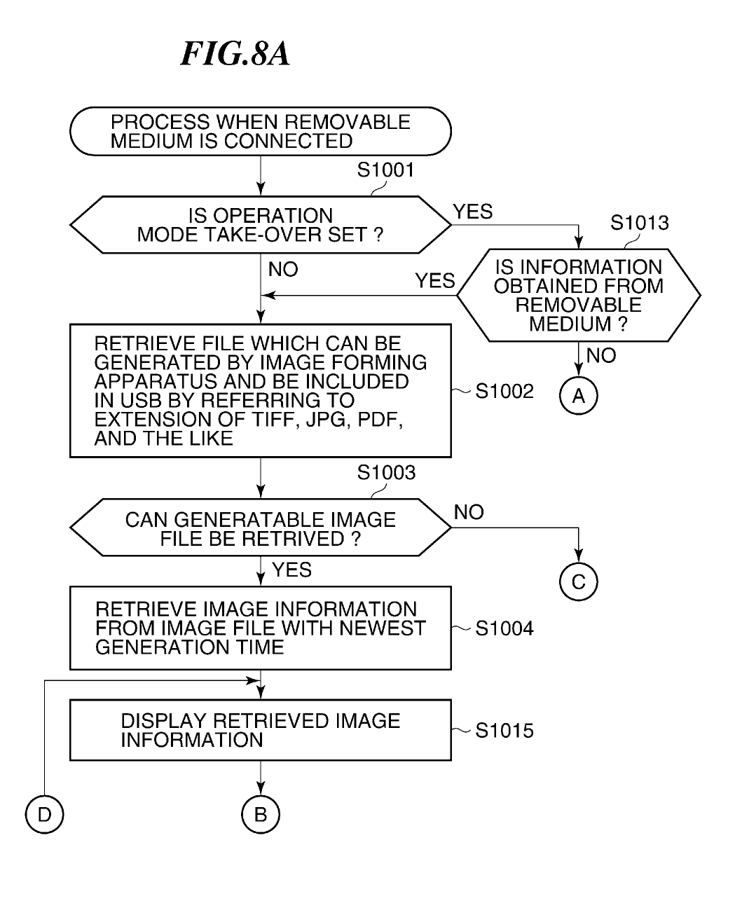

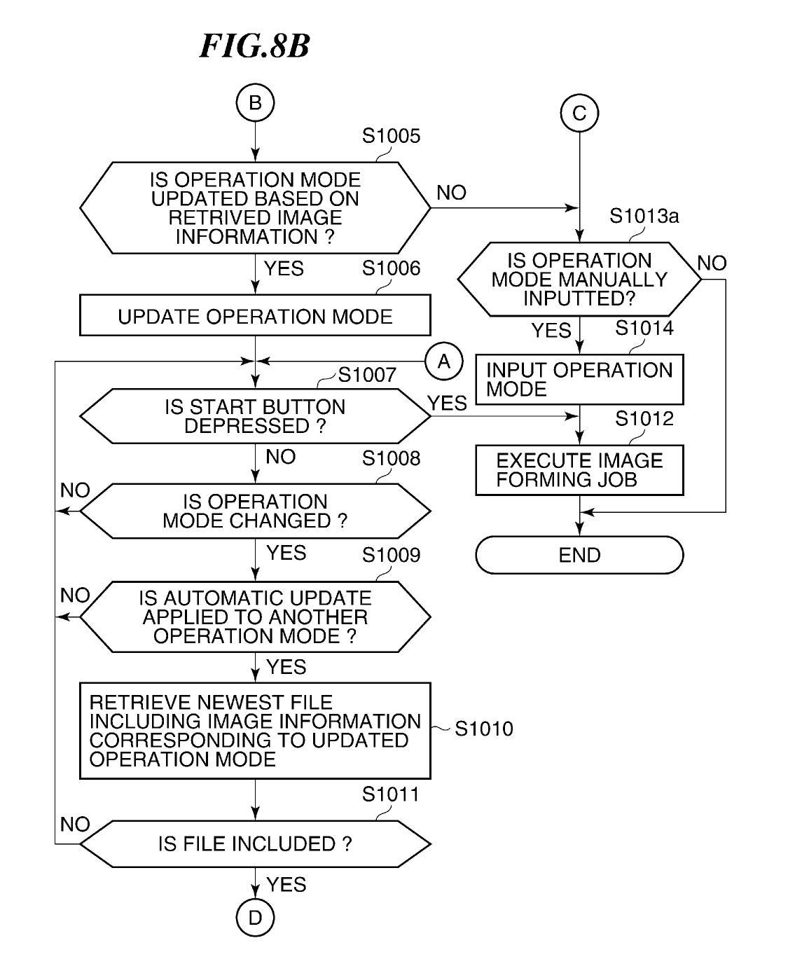

FIGS. 8A and 8B are flowcharts showing a process executed by the MFP 100 of FIG. 1 when the removable medium 125 is connected.

The present flowcharts show a procedure in which the CPU 111 loads the control program stored in the ROM 113 or the hard disk 123 to the RAM 112, and automatically sets the operation mode based on the image data in the removable medium 125.

First, when the removable medium 125 is inserted, the process of the present flowchart is started. Next, in step (S1001), the CPU 111 refers to the information shown in FIG. 7, and checks whether or not the operation mode take-over setting is available.

When the take-over setting is “do”, the CPU 111 confirms the user until a start button is depressed in step (S1013) whether the operation mode is reflected (obtained) from the removable medium 125. When it is instructed from the user to reflect the operation mode, the process proceeds to step (S1002), and when it is not instructed, the process proceeds to step (S1007).

When the take-over setting is “don't”, in step (S1002), the CPU 111 retrieves whether an image file which can be generated by the MFP 100 is included in the removable medium 125.

While data other than images may be also included in the removable medium 125, specifically, the CPU 111 refers to the extension of each file, and retrieves whether a file is included with an extension applicable to a generatable image file. In an example of FIG. 6, a Word file (Registered trademark of Microsoft Corporation) of the fifth line does not correspond to a retrieval target, and the image files of the first to fourth lines correspond to the retrieval targets.

Next, in step (S1003), the CPU 111 checks whether or not the image file is included. When the image file is not included, in step (S1013a), the CPU 111 inquires whether or not the operation mode is manually inputted, and completes this process when the operation mode is not inputted. When the operation mode is inputted, the CPU 111 causes the operation mode to be manually inputted, and executes the image forming job in step (S1012).

When the image file is included in step (S1003), in step (S1004), the CPU 111 generates the table showed in FIG. 6 in the RAM 112 or the hard disk 123, and collects the image parameter (information on the image data) of the image file with the newest date.

In an example of FIG. 6, the file with the date of Sep. 17, 2008 is the newest, so that the image format is the TIFF, a setting value of the color mode is the black and white, and the resolution is 200. In step (S1015), the CPU 111 displays the collected image parameter on the operation panel 122.

In step (S1005), the CPU 111 confirms the user whether the operation mode may be updated based on the collected image information. When the operation mode may not be updated, the CPU 111 executes the process from step (S1013a). When the operation mode may be updated, in step (S1006), the CPU 111 updates the operation mode. For example, when the operation mode is updated based on the image file with the date of Sep. 17, 2008 in the table of FIG. 6, the TIFF of the image format, the black and white of the color mode, and 200 of the resolution are automatically set.

After that, in step (S1007), the CPU 111 checks whether the start button is depressed. When the start button is depressed, in step (S1012), the CPU 111 executes an image forming process by using the automatically-set operation mode, and then terminates the present process.

When the start button is not depressed, the CPU 111 executes the process after step (S1008), and checks the status of the start button again. In step (S1008), the CPU 111 checks whether the automatically-set operation mode is changed by the user.

When the automatically-set operation mode is not changed, the process returns to step (S1007) again. When the automatically-set operation mode is changed, in step (S1009), the CPU 111 confirms the user whether the operation mode should be changed based on the information on the image file corresponding to the changed operation mode.

When the operation mode should not be changed, the process returns to step (S1007). When the operation mode should be changed, in step (S1010), the CPU 111 retrieves the newest image file including the image information corresponding to the changed operation mode.

Particularly, when the file format is changed from the TIFF to the JPEG, the newest image file is found, in which the extension of an image file name is jpg. In FIG. 6, the image file listed-up in the second line becomes a target.

In step (S1011), as a result of the retrieving, when the corresponding image file is included, the process returns to step (S1015), and the CPU 111 displays the information on the retrieved image data, and causes the user to check whether this image information is acceptable, and to update the operation mode, if acceptable. When the updating is executed, in this example, the setting value of the color mode is changed to the color, and the resolution is changed to 600.

When the corresponding file is not included, and when it is determined that the start button is depressed in step (S1007), in step (S1012), the CPU 111 executes an image processing job.

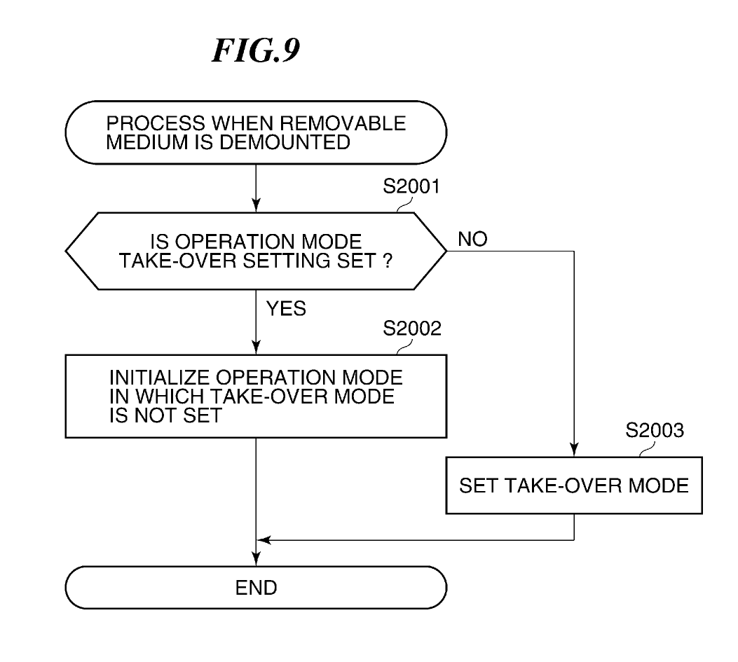

FIG. 9 is a flowchart showing a process executed by the MFP 100 of FIG. 1 when the removable medium 125 is demounted.

The present flowchart shows a procedure of loading the control program stored in the ROM 113 or the hard disk 123 to the RAM 112, and disabling a function for using the removable medium 125.

First, when the removable medium 125 is demounted, in step (S2001), the CPU 111 causes the user to select whether the previously-set operation mode is not taken-over, and is initialized, or the operation mode for maintaining the current condition is taken-over.

When the initialization is selected, in step (S2002), the CPU 111 initializes the operation mode, and sets the choice of operation mode take-over data, which is shown in FIG. 7, reserved in the RAM 112 or the hard disk 123 to “don't”, and then terminates a writing process.

When the take-over is selected, in step (S2003), the CPU 111 does not initialize the operation mode, and sets the choice of the operation mode take-over data, which is shown in FIG. 7, reserved in the RAM 112 or the hard disk 123 to “do”, and then terminates the writing process.

As described above, when the removable medium 125 is connected, it becomes possible that the optimal image file is selected from the image files in the memory, and the operation mode is automatically set based on the image parameter of the selected image file. Thus, it becomes unnecessary to set by a key input from the operation panel 122, and it becomes possible to substantially reduce setting man-hour by the user.

When the automatically-set operation mode is not desirable, and when the operation mode is changed by the user, the image file corresponding to the changed operation mode is retrieved, and the operation mode of the image parameter of the remaining newly-retrieved image file is automatically set, whereby, work for the complex key input can be suppressed.

Further, when the connection of the removable medium 125 is released, it becomes possible to select whether or not the previously-set operation mode is taken-over, so that, even when a plurality of the memory media are used, the setting work for the operation mode can be reduced.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2009-096997 filed Apr. 13, 2009, which is hereby incorporated by reference herein in its entirety.

What is claimed is:

1. An image forming apparatus connected to an external storage apparatus, comprising:
an obtaining unit configured to obtain information indicating resolution or a color mode on image data stored in the connected external storage apparatus;
a setting unit configured to set an operation mode including resolution or a color mode when an image forming job is executed in the image forming apparatus based on the information obtained by said obtaining unit;
a generating unit configured to generate an image file including an image parameter and image data according to the operation mode set by said setting unit; and
a writing unit configured to write the image file generated by said generating unit in the external storage apparatus.

2. The image forming apparatus according to claim 1, further comprising:
a displaying unit configured to display the image parameter as the obtained information on the image data; and
a determining unit configured to determine whether or not the image parameter displayed by said displaying unit is changed.

3. The image forming apparatus according to claim 2, further comprising:
a retrieving unit configured to retrieve the image data including the changed image parameter from the image data stored in the external storage apparatus when said determining unit determines that the image parameter is changed.

4. A control method of an image forming apparatus connected to an external storage apparatus, comprising:
an obtaining step of obtaining information indicating resolution or a color mode on image data stored in the connected external storage apparatus;
a setting step of setting an operation mode including resolution or a color mode when an image forming job is executed in the image forming apparatus based on the information obtained in said obtaining step;
a generating step of generating an image file including an image parameter and image data according to the operation mode set in said setting step; and
a writing step of writing the image file generated in said generating step in the external storage apparatus.

5. A computer-readable storage medium storing a program for causing a computer to implement a control method of an image forming apparatus connected to an external storage apparatus, the control method of the image forming apparatus comprising:
an obtaining step of obtaining information indicating resolution or a color mode on image data stored in the connected external storage apparatus;
a setting step of setting an operation mode including resolution or a color mode when an image forming job is executed in the image forming apparatus based on the information obtained in said obtaining step;
a generating step of generating an image file including an image parameter and image data according to the operation mode set in said setting step; and
a writing step of writing the image file generated in said generating step in the external storage apparatus.
